(19) United States
(12) Patent Application Publication
(10) Pub. No.: US 2005/0218539 A1
(43) Pub. Date: Oct. 6, 2005

(54) Device for making optical storage media unreadable

(76) Inventors: Botho W. Lebe, Raubling (DE); Peter Nohbauer, (US); Adi Ehrnsberger, Munchen (DE)

Correspondence Address: Stephen M. Evans;GRAYBEAL JACKSON HALEY LLP, Suite. 350, 155-108th Avenue N.E., Bellevue, WA, 98004-5901, US

(21) Appl. No.: 11/129,185

(22) Filed: May 12, 2005

Related U.S. Application Data
(63) Continuation-in-part of application No. PCT/EP03/12734, filed on Nov. 14, 2003.

(30) Foreign Application Priority Data
Nov. 14, 2002 (DE) 202 17 688.6

(51) Int. Cl. B29D 17/00

(52) U.S. Cl. 264/1.33; 264/299

(57) ABSTRACT

The device for making optical storage media such as CDs and DVDs unreadable has an element (10) which has a flat slot (12), at least one point projecting into the slot (12). At least one pair and ideally three pairs of coaxial tips aligned opposite each other can project into the slot (12). The element can be a bar (10) approximately 25 to 35 mm in diameter and approximately 150 mm long and the slot (12) can be more than 1 mm high and approximately 50 mm deep and arranged diametrically in the bar (10). One or more headless pins (14) can be screwed perpendicular to the plane of the slot (12) into the element or bar (10) at the front end of which the tips (16) are developed.

The invention relates to a device for making optical storage media unreadable, in particular CDs and DVDs.

Equipment for recording information on CDs is generally available. Due to the low cost of blank CDs, CDs are therefore frequently used to protect information. If the information is no longer required it is to be erased. In the case of CDs this means that they are to be made unreadable. This is intended to prevent a misuse of the stored data.

A method of disposing of CDs is known from JP-A-2000222740 in which the CD is sealed into a foil.

It is known from JP-A-01053352 to arrange two CDs with the read sides facing each other and introduce a solvent between the two CDs which destroys the layers which carry the information.

The objection forming the basis of the invention is to create a simple device for making optical storage media such as CDs and DVDs unreadable.

According to the invention this object is achieved by the device having an element with a slot and at least one (ideally 3 (×2)) tips projecting into the slot.

If a CD is to be made unreadable it is pushed into the slot. In the process the tip(s) projecting into the slot scratches the two surfaces of the CD so that the information stored on the CD can no longer be read.

Preferably, at least six tips aligned opposite each other project into the slot so that a CD pushed into the slot is scratched on both the upper surface and the lower surface—three times on each. The tips are ideally arranged such that they can scratch over the entire radius of the surface of the CD. Reconstruction of the data contained on the CD is then scarcely possible even with considerable outlay.

The element can for example be a bar 25 to 35 mm in diameter and 150 mm long, which has at one end a slot at least 1 mm high, which extends over a length of at least 50 mm. Headless pins are screwed in perpendicular to the plane of the slot at a distance of approx. 5 mm from this bar end, and aligned opposite each other. The headless pins are tapered at the front end and screwed in so far that both tips project into the slot and the distance between the tips is less than the thickness of a CD, thus at most 0.7 mm.

The bar can be composed of metal (for example aluminium), plastic or wood. The headless pins are composed of a material which is clearly harder than the plastic material of the CDs and DVDs. Preferably they are steel pins with hardened tips. The steel pins can be secured against being screwed in or unscrewed—and thus a change in distance—by gluing or fixing with locknuts or self-locking.

In another version of the invention the element is a flat, rectangular sheet the sides of which are 10 and 14 cm long. On one of the long sides a flat, pocket-shaped slot is provided, the width of which is somewhat greater than the diameter of a CD and the depth of which corresponds approximately to the radius of a CD. At a short distance from the opening of the slot, in the centre, (ideally 6) headless pins are provided which are aligned opposite each other. To make it unreadable, a CD is then pushed into the pocket-shaped slot once or several times, one or more scratches then being made on both sides of the CD each time.

In another possible version of the invention the device is developed like a tuning fork and thus has a cylindrical handle from which two or more prongs or fingers extend forward which at their front end have tips aligned opposite each other. The prongs or fingers are expediently made of spring steel so that the tips are pressed into the front back of a CD with the force predetermined by the elasticity of the prongs or fingers.

Preferred embodiments of the invention are explained below with the help of the drawing. There are shown in:

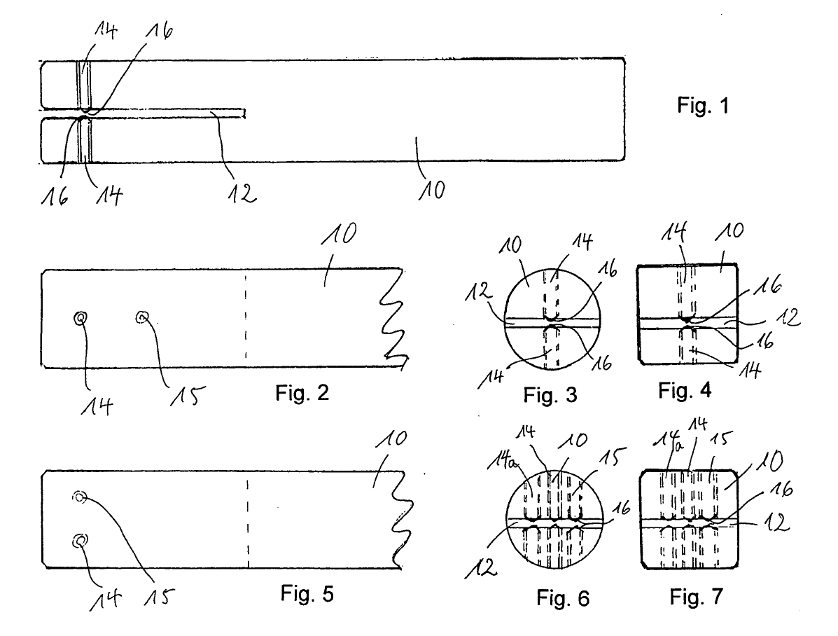

FIG. 1 a device for making CDs and DVDs unreadable, from the side;

FIG. 2 the device of FIG. 1, from above or below;

FIG. 3 the device of FIG. 1, seen from the front;

FIG. 4 another embodiment of the device according to the invention, from the front;

FIG. 5 an embodiment with two pairs of headless pins arranged alongside each other, from above or below;

FIG. 6 the device of FIG. 5, from the front;

FIG. 7 the device of FIG. 5, also from the front, except that the bar has a square cross-section;

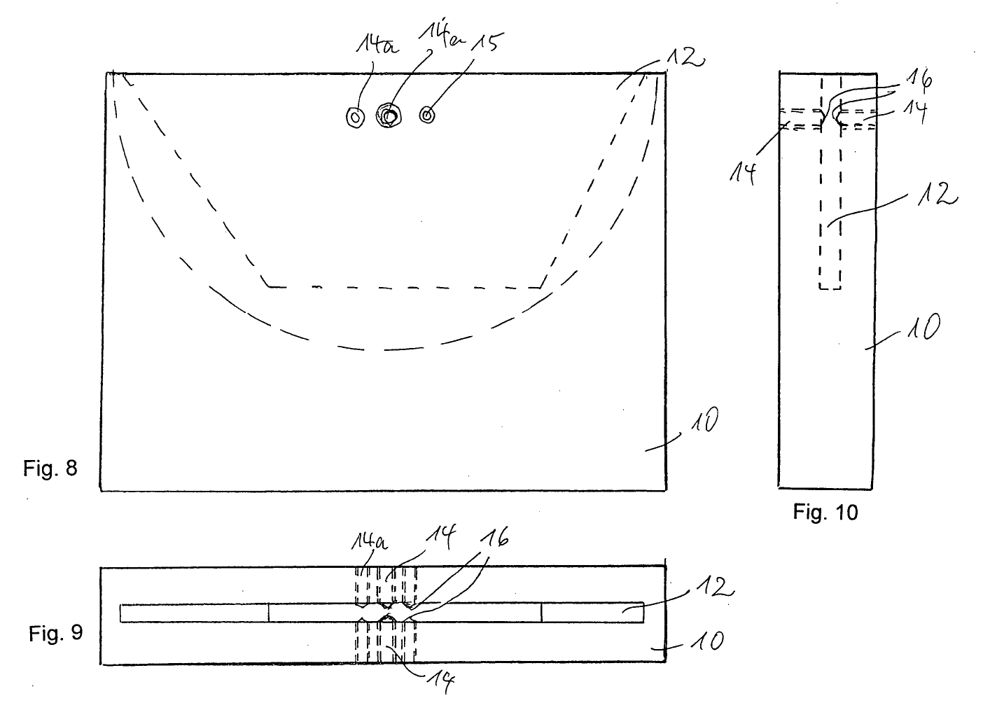

FIGS. 8, 9 and 10 an embodiment in which the device has the shape of a sheet overall;

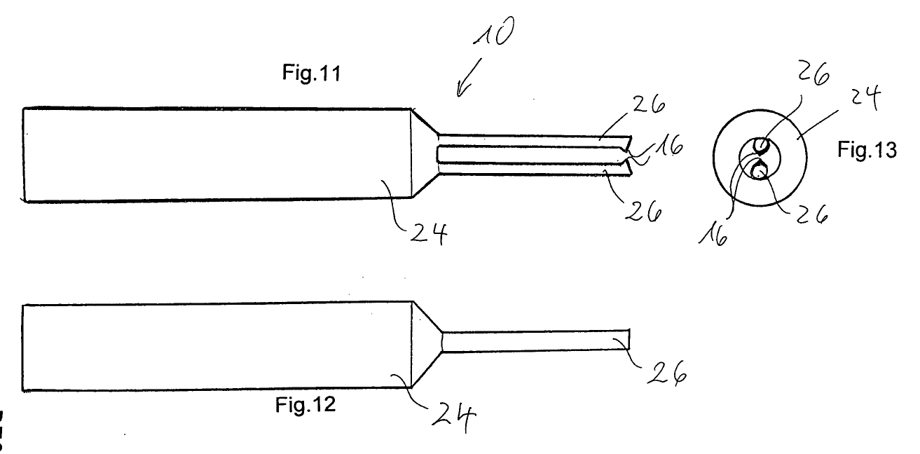

FIGS. 11, 12 and 13 an embodiment in which the device has the form of a fork, and

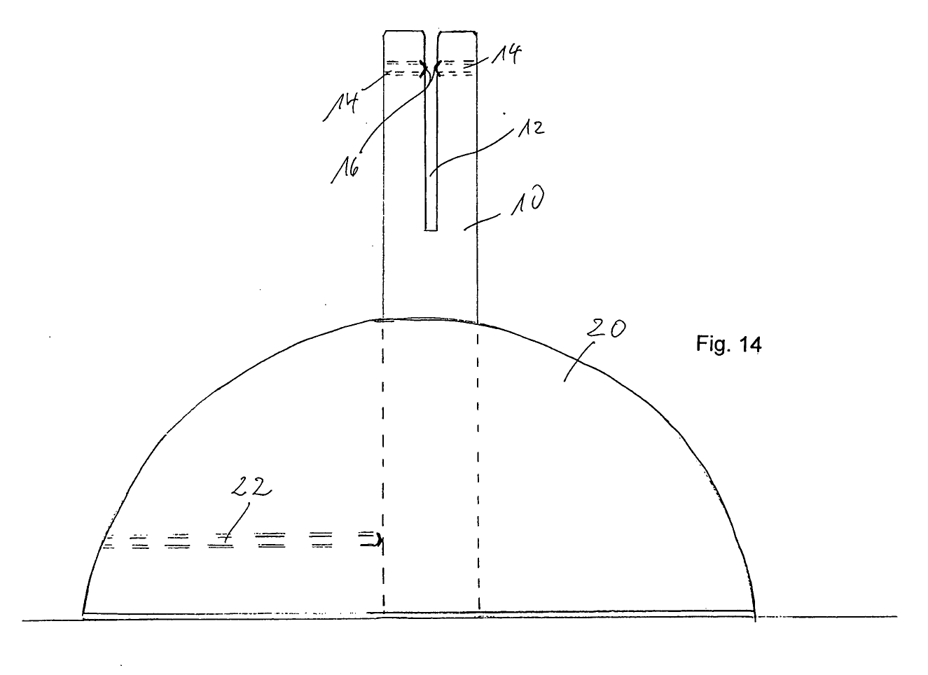

FIG. 14 holding means for the device according to the invention.

The embodiment represented in the drawing of the device according to the invention has an element in the form of a bar 10 of circular cross-section. The length of the bar 10 is 150 mm and the diameter 25-35 mm. At the left end of the bar in FIG. 1 there is a slot 12 which passes through the entire diameter of the bar 10 and is between 50 and 52 mm long. Perpendicular to the plane of the slot 12, coaxial headless pins 14, 14a and 15 opposite each other are screwed into the bar 10 in corresponding threaded bores, at a short distance from the front, left end of the bar in FIG. 1. In the represented embodiment the distance is approximately 5 mm.

The headless pins 14, 14a and 15 have a conical point 16 at the end which projects into the slot 12. The tips 16 of the coaxial headless pins 14, 14a and 15 are, as can be seen in FIG. 1, aligned opposite each other and the distance between them is approximately 0.3 mm less than the thickness of a CD which is to be made unreadable by means of the device. The two tips thus each project an equal distance into the slot 12.

The headless pins 14, 14a and 15 are provided with a hexagon socket at their outer end.

FIG. 2 shows the device of FIG. 1 in top view. A second or third pair of headless pins 15 are drawn in which can optionally be present.

Three pairs of headless pins 14, 14a and 15 are aligned alongside each other in the embodiments of FIGS. 5 to 7. The cross-section of the bar 10 can be circular or square or similar.

The device according to the invention is used such that the optical storage medium, e.g. a CD, is pushed into the slot 12 until the edge of the CD touches the end of slot 12. Both the top and bottom of the CD are scratched by the tips 16 of the headless pins 14, 14a and 15. If at least 6 scratches are made on the CD in this way, the CD can no longer be read by customary CD drives.

FIGS. 8, 9 and 10 show an embodiment in which the element has the form of a rectangular sheet 10 the sides of which are approx. 110 and 150 mm long and which is approx. 20 mm thick. Starting from one of the long sides, in the middle plane of the sheet a slot 12, approximately 5 mm high, is provided which extends over almost the entire length of the side and is approximately 55 mm deep, thus slightly less than the radius of a CD. The slot 12 has a trapezoidal outline, but can also be semi-circular. Headless pins 14, 14a and 15 are screwed in, somewhat set back from the middle of the opening of the slot 12, on the top and bottom of plate 10, their conical tips 16 projecting into the slot 12 and being spaced at most 0.7 mm from each other.

This device is operated analogously to the preceding examples, i.e. a CD is pushed into the slot 12 once or repeatedly at various points of its periphery to make it unreadable. The scratches produced make it unreadable.

FIGS. 11 to 13 show an embodiment in which the device is developed like a tuning fork. The element is composed of a handle 24 and at least two prongs or fingers 26 which project axis-parallel to it from the handle 24 and parallel to each other. The prongs 26 have an oval or circular cross-section, but can also have a rectangular cross-section. They are at least 50 mm long. The tips 16 are moulded on at the front end of the prongs 26. The prongs 26 extend away from a mandrel and are for example made of spring steel.

The use of this embodiment is analogous to that in FIGS. 1 to 3.

FIG. 14 shows a table model of the device according to the invention. The point 10 is introduced into a foot 20 and secured there by means of a steel pin 22. The weight of the foot is such that the weight force is greater than the force required to pull out the CD from slot 12, so that the table model is not raised when the CD is pulled out.

### Reference Numbers

10 Element (point, plate)
12 Slot
14 Headless pin
14a Headless pin
15 Headless pin
16 Point
20 Foot
22 Headless pin
24 Handle
26 Fingers, prongs

1. A device for making optical storage media such as CDs and DVDs unreadable, comprising an element which has a flat slot, at least one pair of coaxial points arranged opposite each other and projecting into the slot.

2. The device according to claim 1, wherein at least two pairs of coaxial points are arranged opposite each other and project into the slot.

3. The device according to claim 1, wherein the element is a bar approximately 25 to 35 mm in diameter and approximately 150 mm long and that the slot is more than 1 mm high and approximately 50 mm deep and arranged diametrically in the bar.

4. The device according to claim 1, wherein one or more headless pins are screwed into the element or bar perpendicular to the plane of the slot, at the front end of which the tips are developed.

5. The device according to claim 1, wherein the element is a sheet and the slot is parallel to the plate plane from one of the side surfaces of the plate and is trapezoidal or semi-circular, so that it can house approximately half of the optical storage medium, and the tips projecting into the slot are provided a short distance from the opening edge of the slot.

6. The device according to claim 1, wherein the element has a handle and prongs, projecting axis-parallel from it a small distance apart, at the front end of which the tips are provided.
